(19) United States
(12) Patent Application Publication
(10) Pub. No.: US 2008/0300162 A1
(43) Pub. Date: Dec. 4, 2008

(54) Solid Fabric Softening Composition

(75) Inventors: Vikki Louise Binns, Hull (GB); Anne Tindal, Hull (GB)

Correspondence Address: NORRIS, MCLAUGHLIN & MARCUS, 875 THIRD AVE, 18TH FLOOR, NEW YORK, NY, 10022, US

(73) Assignee: RECKITT BENCKISER (UK) LIMITED, Slough (GB)

(21) Appl. No.: 11/577,441

(22) PCT Filed: Oct. 18, 2005
(86) PCT No.: PCT/GB05/04023

§ 371 Date: May 7, 2007

(30) Foreign Application Priority Data
Oct. 20, 2004 (GB) 0423250.0

(51) Int. Cl. C11D 3/00

(52) U.S. Cl. 510/519

(57) ABSTRACT

A solid fabric softening composition which is suitable for adding to a heated tumble dryer along with fabric articles comprises a cationic softening agent, a sublimable carrier substance and talc. The composition disintegrates to provide softening with a reduction in risk of greasy spots.

The present invention relates to a solid fabric softening composition which is added to a dryer along with fabric articles. In particular it is concerned with compositions in solid form which are in the form of tablets, bars, pellets or sheets and which are free of any supporting substrate or matrix which must be removed from the dryer after use.

In the literature of the field, the words softening and conditioning are often used synonymously, whereas in more recent years, conditioning has come to have a broader meaning, encompassing such effects as antistatic, soil repellency, ease of ironing, crease prevention and even perfuming. In this description, softening means reduction in the harsh feel of a fabric or textile and/or improved fabric smoothness.

When fabric washing was carried out with soaps, softeners were not generally needed because the salts present in hard water would react with the soaps to form calcium soaps. These calcium soaps had a lubricating effect which would cancel out the harsh feel of a freshly washed and rinsed textile. With the advent of synthetic detergents, softening agents were needed, and it was found that cationic surfactants could act to reduce the harshness of washed textiles. Because of the formation of coacervates between anionic, detergent surfactants and cationic softening surfactants, separate softening products were created necessitating modification of washing machines to allow introduction of softening compositions at the end of the rinse cycle to maximise efficiency.

The early products were added as liquids to the final rinse to ensure even distribution of the cationic surfactant over the surface of the fabrics being washed.

When heated air tumble dryers became common for drying clothes after washing, alternative forms of softening product were developed to be applied directly to the damp textiles in the dryer, saving on waste of softening material and any accompanying fragrance, which would be partially rinsed away for compositions added to the rinse cycle of the wash. An important, secondary effect provided by commercial softening products is that of providing fragrance to the fabric articles.

It is known that fabrics can be softened in a dryer such as a tumble dryer by mingling the damp fabrics with a flexible substrate carrying a fabric-softening agent. See for example U.S. Pat. Nos. 3,895,128, 4,327,133 and WO 95/27777. According to U.S. Pat. No. 4,327,133, if clothing to be softened is placed into a dryer directly with a pure fabric softening agent such as distearyl dimethyl ammonium chloride, the softener will be far from uniformly spread and may lead to unsightly spots and water repellency of the fabric. Moreover free hydrochloric acid present as impurity from the chloride softening agent may lead to corrosion of the fabric.

Dryer sheets soften fabrics by the direct transfer of molten softening agent to the fabrics to be conditioned. This is taught in Surfactant Science Series 2, vol 37 (pub. Marcel Dekker 1991).

According to “Formulating Detergents and Personal Care Products” by L. Ho Tan Tai (AOCS Press 200) page 183, dryer sheets have problems of fatty stains caused by uneven deposition of the softener and blockage of air filter entries and exits caused by the sheets left behind after the softener material has been transferred to the textiles. Moreover, the sheets may become tangled with the fabric items and so fail to distribute the softening agent adequately. Also the sheets have to be manually recovered and are discarded and thus wasted material. Furthermore there is no end of life indication, that is, there is no signal which shows that the sheets are void of active material.

EP 459 488 discloses a dryer sheet which is coated with a formulation comprising compatible organosilicones to enhance spreading of the fabric softening agent on the textile surface.

U.S. Pat. No. 4,328,110 discloses a substrateless dryer-added fabric conditioning product in a tablet form including filler, binder/disintegrant and lubricant to facilitate tabletting.

WO 2004/037964 discloses a textile treatment delivery system comprising a textile conditioning composition, and a fragrance in a sublimable carrier substance, preferably adamantane.

It has now been found that a solid fabric softening composition comprising a cationic softening agent, a sublimable carrier substance and talc can provide softening of fabrics when combined with fabrics in a heated tumble dryer, while avoiding many of the problems of prior art fabric softening products.

Hence in a first aspect, the invention provides a solid fabric softening composition suitable for placing with fabric articles in a tumble dryer comprising a cationic softening agent, a sublimable carrier substance and talc.

By solid fabric softening composition, it is meant that the composition is in the form of an elastic or plastic solid at conventional consumer product storage temperatures of 37° C. or less.

By sublimable, it is meant that the carrier substance undergoes a phase conversion from solid to vapour phase without first melting. The sublimation temperature is defined here as the temperature at which the vapour in equilibrium with the solid has a vapour pressure of one standard atmosphere (101.325 kPa).

In practice, a substance will sublime at a temperature below the sublimation temperature provided that the ambient vapour pressure of the substance in the surrounding atmosphere is less than the equilibrium vapour pressure. For the practical applicability of the compositions according to the invention, the sublimation temperature of the sublimable material should be such that at a temperature of 60° C., the equilibrium vapour pressure is 0.1 standard atmospheres or more, preferably 0.3 or more, more preferably 0.5 or more.

The sublimable carrier substance is suitably present at a level of from 10 to 90%, preferably from 30 to 85%, more preferably from 40 to 80% by weight of the composition of the invention.

The sublimation temperature of the sublimable carrier substance is suitably from 45 to 225° C., preferably from 50 to 150° C.

A particularly preferred sublimable carrier substance is adamantane. Adamantane is tricyclo (3,3,1,1) decane and has been found to give particularly good sublimation behaviour in combination with low environmental impact and toxicity.

The cationic softening agent is suitably a cationic surfactant or a cationically substituted homopolymer or copolymer. Preferably the cationic softening agent is a cationic surfactant. Suitable cationic surfactants include molecules with a quaternary nitrogen atom as part of the head group of the molecule. Quaternary ammonium surfactants are preferred. Preferably, the cationic softening agent is a quaternary ammonium compound according to formula I

R₁R₂R₃R₄[N]⁺X⁻ I

In formula I, R₁ and R₂ are each independently saturated alkyl chains, either linked directly to the quaternary nitrogen, or optionally one or more may be linked to the quaternary nitrogen by an ester linkage. Each alkyl chain R₁, R₂ has a chain length independently from C₁₂ to C₂₂, preferably from C₁₄ to C₁₈, not including the carbon in any ester linkage. R₃ and R₄ are each independently hydrogen, C₁-C₄ alkyl or C₁-C₄ hydroxyalkyl. X⁻ is an anion selected from halogen, (e.g. chloride, bromide) acetate, citrate, lactate, glycolate, phosphate, nitrate, sulphate, alkosulphate (e.g. methosulphate or ethosulphate).

Fabric conditioning agents according to formula I can be used to provide a solid fabric softening composition which is not sticky to handle at ambient temperatures and which is amenable to extrusion and tabletting. An example of a particularly preferred fabric conditioning agent is di C₁₄-C₁₈ alkyl dimethyl ammonium methosulphate, e.g. Quaternium-18 Methosulphate (CTFA). This is available commercially in the form of a solid as Varisoft™ DS-150.

It has been found that methosulphate salts give lowered risk of fabric corrosion compared to halides.

Saturated alkyl chains R₁,R₂ give advantages over unsaturated alkyl chains in that they provide greater retention of form and shape for the articles formed from the fabric conditioning composition during manufacture and storage.

Cationic softening agents are generally made available commercially as solid, pastes or solutions, where the cationic softening agent is present as a blend with other materials either as solvents or present as by-products of the manufacturing process. It is preferred that the cationic softening agent for use in the compositions of the invention is in the form of a solid at 37° C. or less in its commercially available form.

Suitably, compositions according to the invention comprise from 1% to 25% by weight of cationic softening agent, preferably from 2% to 20%, more preferably from 5 to 15%.

It is also preferred that the compositions of the invention comprise less than 1% by weight of isopropyl alcohol, more preferably less than 0.5%, even more preferably less than 0.1%.

It is also preferred that the composition of the invention further comprises a paraffin wax. Suitably the paraffin wax is present in an amount of from 10 to 30 wt %, preferably 10 to 25 wt %, more preferably 20 to 25 wt %.

Compositions of the invention also include talc. Talc is an inorganic mineral: magnesium silicate hydroxide.

It has been found that talc is particularly effective as a distribution aid in preventing the appearance of spots or greasy marks on the fabric articles after drying while not leading to a powdery appearance on the clothes, even when present at levels as high as 3% by weight of the solid fabric conditioning composition. Other distribution aids such as calcite or clays do not provide this advantageous behaviour, and it is preferred that the compositions of the invention have less than 0.5%, more preferably less than 0.1% by weight of inorganic solids, with a melting point in excess of 200° C., other than talc.

A suitable median particle diameter (D₅₀ based on particle weight: i.e. 50% by weight of the particles have a diameter less than the median diameter) for talc when used in the composition of the invention of the invention is from 1 to 15 micrometres, more preferably from 2 to 12 micrometres, and most preferably from 4 to 10 micrometres. The median particle diameter may be measured by light scattering using suitable apparatus such as a Malvern Mastersizer™.

The talc is suitably present at a level of from 0.1 to 4%, preferably 0.5 to 3% by weight of the solid fabric softening composition of the invention.

A preferred, optional ingredient of the compositions of the invention is a silicone wax, which has been found to give excellent fragrance substantivity on the fabric articles after drying, when fragrance is present as part of the composition. A problem with prior art compositions was the amount of fragrance last during the drying process in the tumble dryer rather than deposited onto the fabric articles.

Suitable silicone waxes are those which have a polyorganosiloxane backbone, with some of the silicone monomers substituted with a long chain alkyl group, such that the material is a waxy solid at 20° C. Suitable silicone waxes and methods for their manufacture are described in U.S. Pat. Nos. 3,563,941 and 3,395,169. Preferably, the long chain alkyl substituent has an alkyl chain comprising from 16 or more carbon atoms, preferably 30 or more. Suitably the alkyl substituent has an alkyl is chain comprising 80 or less carbon atoms, preferably 60 or less. Suitably, the silicone wax is a plastic solid at 20° C. and has a melting point of 45° C. or more, preferably 60° C. or more.

Examples of suitable waxes include cetyl dimethicone (Abil Wax™ 9801 ex Goldschmidt) and stearoxy dimethicone.

A particularly preferred wax is Dow Corning™ 2-5088 Wax, which comprises the reaction product of methyl hydrogen siloxane with an alpha olefin fraction having a chain length in excess of C₃₀, having the CAS number 189378-12-9.

Silicone wax, when present, is preferably at a level of from 1% to 20% by weight of the composition, more preferably from 3% to 18%, most preferably from 4% to 16%.

Solid fabric softening compositions of the invention may comprise a fragrance. The fragrance may be any material that will leave a pleasing aroma on the fabric articles, and which is capable of enduring the heating of the tumble dryer without significant decomposition. Preferably the fragrance composition will comprise one or more aroma chemicals which exhibit a low vapour pressure, i.e. less than 10⁻⁴ standard atmospheres at 20° C.

All known fragrance compositions may be considered for use in compositions of the invention: a skilled formulator would have no difficulty in the selection of a suitable fragrance blend. Suitably, the fragrance is present in the solid fabric softening composition of the invention at a level from 0.5 to 20% by weight of the composition, preferably from 1.5 to 15% more preferably from 2.5 to 10%.

Other functional ingredients such as further conditioning agents, water, antistatic agents, easy-iron agents, etc may also be incorporated into the compositions of the invention provided they do not compromise the performance of the composition. Preferably such ingredients are present at a total level of 1% by weight of the composition or less.

Although the composition of the invention may be in the form of a solid deposited onto a woven or non-woven sheet of material, in a manner as disclosed in WO 95/27777, it is preferred that the composition is free of any supporting substrate or matrix which must be removed from the dryer and separated from the softened fabric articles after use. Another aspect of the invention provides a solid article in the form of a tablet, prill, noodle or sheet consisting of the solid fabric softening composition as detailed above.

A suitable process for making compositions according to the invention comprises the sequential steps of:

i) melting the cationic softening agent and any silicone wax into a liquid blend,

ii) adding any water and the talc to the blend in finely divided form,

iii) adding the sublimable carrier substance, and any other ingredients, including fragrance, to the blend,

iv) dispersing the ingredients to form a homogeneous blend and

v) allowing the blend to cool and solidify.

While still in a fluid state, the blend may be cast into a suitable shape. Alternatively, when the melt is partially solidified into a plastic state, it may be tabletted or extruded into a final product form such as noodles or a billet. A preferred method for forming the composition of the invention into a tablet form is to extrude a billet of the composition and to slice the billet into tablets.

A particularly preferred process is a co-extrusion process using a single or twin screw mixer-extruder, wherein the cationic softening agent is dosed into the extruder in a molten state, preferably at a temperature from 60 to 100° C., and downstream addition of the other ingredients is made with the other ingredients at room temperature (i.e. from 15 to 35° C.). The resulting composition is extruded from the extruder-mixer as noodles or as a billet.

The mixer-extruder is preferably jacketed with a temperature control system whereby the exit temperature of the homogenised composition may be controlled.

If a product form of prills is required, these may be formed by spray-cooling the melt. If a product in the form of powder or granules is required, this may be formed by mechanical comminution of the solid composition. Optionally, the composition may be cooled to a low temperature, say −10° C. or less, to prevent problems due to partial melting during comminution.

Another method to obtain the composition of the invention is to dry-blend the ingredients of the invention, with all of the ingredients in a finely divided form. The dry blend may then be tabletted by compressive tablettting.

Suitably, the solid fabric conditioning composition of the invention is used at total weight is from 1 to 10 gm, preferably from 2 to 6 gm per tumble dryer load of fabric articles. Although the load is preferably damp, the weight when dry is preferably 2 to 6 kg of fabric articles, more preferably 3 to 5 kg. Although the composition of the invention may be used with dry fabric articles in a tumble dryer, it is preferred that the articles are damp. Preferably, the composition is added to damp articles which have been washed, rinsed and spun to partially dry them.

A second aspect of the invention is concerned with a method for conditioning fabrics comprising tumbling the fabrics with a solid fabric softening composition comprising a cationic softening agent, a sublimable carrier substance and talc, in a heated tumble dryer with a hot air temperature of 35° C. or more.

A preferred method for conditioning fabrics comprises the steps of:

i) washing and rinsing the fabric articles in water, preferably partially spin-drying the fabric articles, whereby the fabric articles are damp,

ii) placing the damp fabric articles in a tumble dryer along with a solid fabric softening composition comprising a cationic softening agent, a sublimable carrier substance and talc,

iii) drying the fabric articles along with the solid fabric softening composition in the tumble dryer with a hot air temperature of 35° C., preferably 45° C. or more.

The tumble dryer may be a separate dryer or may be a combined washer and dryer. In the latter case, the solid fabric conditioning composition is added to the machine after the final spin and before or during the drying cycle.

The heated air temperature in the dryer is suitably 35° C. or more, preferably 45° C. or more, more preferably 60° C. or more, even more preferably 70° C. or more to ensure sublimation of the sublimable carrier substance and uniform distribution of the ingredients over the fabric articles. Preferably the hot air has a temperature of less than 120° C., more preferably less than 110° C. Where the temperature in the dryer varies with time, the heated air temperature refers to the time averaged mean temperature over the drying period.

The invention will now be further described, by way of Examples.

### EXAMPLE 1

A tablet having a weight of 2.5 g was prepared according to the formulation in table 1:

TABLE 1

| Ingredient | Weight % |
|---|---|
| Adamantane | 61.6 |
| Varisoft ™ DS-150 | 18.0 |
| Talc | 2.0 |
| Fragrance | 3.4 |
| Dow Corning ™ 2-5088 Wax | 15.0 |

Varisoft™ DS 150 is a commercial cationic surfactant comprising from 50 to 60% by weight of di (C₁₄-C₁₈ alkyl) methosulphate quaternary ammonium compound. Dow Corning™ 2-5088 Wax is a commercially available silicone wax. The talc is sterilised, industrial grade talc from the supplier Albion. The fragrance was a commercial fragrance supplied by Givaudan for use in fabric conditioner compositions.

The tablet was prepared by melting the Varisoft™ and silicone wax together in a beaker on a heated plate to form a molten blend at 80° C. The beaker was then removed from the hot plate and talc, fragrance and adamantane were blended into the melt sequentially and the blend was allowed to cool to 25° C.

The resulting solid mass was removed from the beaker and compacted into a cylindrical tablet using a simple tablet press.

The tablet was found to give conditioning when added to damp fabrics in a heated tumble dryer, without appreciable levels of visible residues or spotting on the articles.

### EXAMPLE 2

A tablet was prepared in a similar manner as in Example 1 except that the formulation was as set out in table 2:

TABLE 2

| Ingredient | Weight % |
|---|---|
| Adamantane | 63.6 |
| Varisoft ™ DS-150 | 5.0 |
| Talc | 2.0 |
| Fragrance | 3.4 |
| Paraffin Wax | 21.0 |
| Dehyquart F30 | 5.0 |

Dehyquart F30 is a commercial cationic surfactant comprising cetearyl alcohol and dipalmitoylethyl hydroxyethylmonium methosulfate.

The tablet was again found to give conditioning when added to damp fabrics in a heated tumble drier, without visible residues or spotting on the articles.

1. A solid fabric softening composition suitable for placing with fabric articles in a tumble dryer comprising a cationic softening agent, a sublimable carrier substance and talc.

2. A composition according to claim 1 wherein the sublimable carrier substance is adamantane.

3. A composition according to claim 1 wherein the cationic softening agent is a cationic surfactant.

4. A composition according to claim 3 wherein the cationic surfactant is a quaternary ammonium compound according to formula I
R₁R₂R₃R₄[N]⁺X⁻ I
wherein R₁ and R₂ are each independently saturated alkyl chains, either linked directly to the quaternary nitrogen or linked to the quaternary nitrogen by an ester linkage and wherein each alkyl chain R₁, R₂ has a chain length independently from C₁₂ to C₂₂, not including the carbon in any ester linkage and wherein R₃ and R₄ are each independently hydrogen, C₁-C₄ alkyl or C₁-C₄ hydroxyalkyl and wherein X⁻ is an anion selected from halogen, acetate, citrate, lactate, glycolate, phosphate, nitrate, sulphate, methosulphate and ethosulphate.

5. A composition according to claim 1 comprising from 0.1 to 4% by weight of talc.

6. A composition according to claim 1 comprising from 10 to 90% by weight of sublimable carrier substance and from 1% to 25% by weight of cationic softening agent.

7. A composition according to claim 1 which further comprises a paraffin wax.

8. A method for conditioning fabrics comprising the steps of:
tumbling the fabrics with a solid composition according to claim 1 in a heated tumble dryer with a hot air temperature of 35° C. or more.

9. (canceled)
